(19) United States
(12) Patent Application Publication
(10) Pub. No.: US 2021/0385633 A1
(43) Pub. Date: Dec. 9, 2021

(54) USER PLANE FUNCTION CONFIGURATION METHOD AND APPARATUS, AND DEVICE

(71) Applicants: China Mobile Communication Co., Ltd Research Institute, Beijing (CN); China Mobile Communications Group Co.,Ltd., Beijing (CN)

(72) Inventors: Dan WANG, Beijing (CN); Tao SUN, Beijing (CN); Chao LIU, Beijing (CN)

(21) Appl. No.: 17/265,959

(22) PCT Filed: Jul. 22, 2019
(86) PCT No.: PCT/CN2019/097039

§ 371 Date: Feb. 4, 2021

(30) Foreign Application Priority Data
Aug. 13, 2018 (CN) 201810916161.3

(51) Int. Cl. H04W 4/50; H04W 28/02; H04W 12/80; H04M 15/00

(52) U.S. Cl. CPC H04W 4/50; H04M 15/66; H04W 12/80; H04W 28/0268

(57) ABSTRACT

The present disclosure relates to the field of communication technology, and provides a UPF configuration method, a UPF configuration apparatus and a device. The UPF configuration method for a network device includes calling a policy control service of a UPF. The policy control service is used to configure a network policy for the UPF, or configure the network policy and network policy triggering information for the UPF.

### CROSS-REFERENCE TO RELATED APPLICATION

The present application claims a priority of the Chinese patent application No. 201810916161.3 filed on Aug. 13, 2018, which is incorporated herein by reference in its entirety.

### TECHNICAL FIELD

The present disclosure relates to the field of communication technology, in particular to a User Plane Function (UPF) configuration method, a UPF configuration apparatus, and a device.

### BACKGROUND

In a 5^{th}-Generation (5G) mobile communication network, network architecture has been designed in an innovative manner on the basis of functions and logics of the mobile communication system, and Service-based Architecture (SBA) has been proposed. As shown in FIG. 1, several services relatively independent from each other and capable of being called flexibly form network functions, and these functions are configured to provide services for any licensed network function via a uniform interface. In the 5G network architecture, a control plane is separated from a user plane. The control plane is implemented in a service-based manner, different network functions (NFs) communicate with each other through calling an interface designed using Hyper Text Transfer Protocol (HTTP), and the NFs are divided into different service implementations.

To be specific, the 5G core network architecture includes the following network functions.

Access and Mobility Management Function (AMF), which takes charge of such functions as network access control, registration management, connection management and mobility management for a 5G user.

Session Management Function (SMF), which takes charge of such functions as life cycle management of a session, Internet Protocol (IP) address assignment, data routing, business continuity management, policy rule matching and flow charging for the 5G user.

UPF, which takes charge of such functions as routing and forwarding of a user data message, service identification and policy enforcement.

Unified Data Repository (UDR), which takes charge of the storage of 5G user data, policy data and capability exposure data.

Unified Data Management (UDM), which takes charge of such functions as authorization and authentication of the 5G user, and mobility management.

Policy Control Function (PCF), which provides such functions as non-session policy management, e.g., access control for the 5G user or slice selection, and session policy management, e.g., session binding, session control, Quality of Service (QoS) control or charging control.

Network Slice Selection Function (NSSF), which assists in the selection of a 5G network slice instance.

Short Message Service Function (SMSF), which transmits and receives a short message service through Non-Access Stratum (NAS) signaling.

Binding Support Function (BSF), which provides a session binding service within a 5G core network.

Network Function Repository Function (NRF), which takes charge of the registration and discovery of service-based functions of each network element in the core network.

Network Exposure Function (NEF), which takes charge of exposing service-based capability and information of the 5G core network to an external network.

Network Data Analytics Function (NWDAF), which takes charge of collecting and analyzing network status information (e.g., a congestion condition of a network slice), and providing policy decision information to a PCF network element.

Application Function (AF), which may be an application from a third party, or a self-operated business of an operator. When the AF is an application from the third party, the AF needs to interact with the PCF or UDM via the NEF.

(Radio) Access Network ((R)AN).

However, the 5G SBA in the related art merely supports the service procedures of an interface in the control plane of the 5G core network, so the UPF needs to have a universal set of functions. In the implementations of different slices, the functions of the UPF may probably be wasted.

### SUMMARY

An object of the present disclosure is to provide a UPF configuration method, a UPF configuration apparatus, and a device, so as to call functions of the UPF on demand, thereby to prevent the occurrence of resource waste.

In one aspect, the present disclosure provides in some embodiments a UPF configuration method for a network device, including calling a policy control service of a UPF. The policy control service is used to configure a network policy for the UPF, or configure the network policy and network policy triggering information for the UPF.

In a possible embodiment of the present disclosure, the policy control service includes at least one of policy control service creation, policy control service update and policy control service deletion.

In a possible of the present disclosure, the network policy includes at least one of QoS policy, lawful interception policy and charging policy.

In a possible embodiment of the present disclosure, the network policy triggering information indicates that a corresponding network policy is triggered when the transmission of a data packet has been detected after the establishment of a Packet Data Unit (PDU) session; or indicates that a corresponding network policy is triggered when the transmission of a target data stream has been detected after the establishment of the PDU session.

In a possible embodiment of the present disclosure, the calling the policy control service of the UPF includes: transmitting a first service request to the UPF, the first service request including the network policy, or the network policy and the network policy triggering information; and receiving a first service response from the UPF.

In a possible embodiment of the present disclosure, prior to calling the policy control service of the UPF, the UPF configuration method further includes inquiring of a PCF about a network policy corresponding to a second service request from a User Equipment (UE) in accordance with the second service request, and inquiring of an NRF about a UPF service corresponding to the second service request.

In a possible embodiment of the present disclosure, the second service request includes a PDU session establishment request.

In a possible embodiment of the present disclosure, prior to calling the policy control service of the UPF, the UPF configuration method further includes calling a transmission path establishment service of the UPF during the establishment of the PDU session, and establishing a policy control service calling path with the UPF. The calling the policy control service of the UPF includes calling the policy control service of the UPF through the policy control service calling path.

In another aspect, the present disclosure provides in some embodiments a UPF configuration method for a UPF, including performing configuration in accordance with a policy control service. The policy control service is used to configure a network policy for the UPF, or configure the network policy and network policy triggering information for the UPF.

In a possible embodiment of the present disclosure, the policy control service includes at least one of policy control service creation, policy control service update and policy control service deletion.

In a possible of the present disclosure, the network policy includes at least one of QoS policy, lawful interception policy and charging policy.

In a possible embodiment of the present disclosure, the network policy triggering information indicates that a corresponding network policy is triggered when the transmission of a data packet has been detected after the establishment of a PDU session; or indicates that a corresponding network policy is triggered when the transmission of a target data stream has been detected after the establishment of the PDU session.

In a possible embodiment of the present disclosure, the performing the configuration in accordance with the policy control service includes: receiving a first service request from a calling end, the first service request including the network policy, or the network policy and the network policy triggering information; and transmitting a first service response to the calling end after performing the configuration in accordance with the first service request.

In a possible embodiment of the present disclosure, prior to performing the configuration in accordance with the policy control service, the UPF configuration method further includes registering a service supported by the UPF itself to an NRF via a service-based interface.

In yet another aspect, the present disclosure provides in some embodiments a network device, including a first processor and a first transceiver. The first processor is configured to call a policy control service of a UPF. The policy control service is used to configure a network policy for the UPF, or configure the network policy and network policy triggering information for the UPF.

In a possible embodiment of the present disclosure, the policy control service includes at least one of policy control service creation, policy control service update and policy control service deletion.

In a possible of the present disclosure, the network policy includes at least one of QoS policy, lawful interception policy and charging policy.

In a possible embodiment of the present disclosure, the network policy triggering information indicates that a corresponding network policy is triggered when the transmission of a data packet has been detected after the establishment of a PDU session; or indicates that a corresponding network policy is triggered when the transmission of a target data stream has been detected after the establishment of the PDU session.

In a possible embodiment of the present disclosure, the first transceiver is configured to: transmit a first service request to the UPF, the first service request including the network policy, or the network policy and the network policy triggering information; and receive a first service response from the UPF.

In a possible embodiment of the present disclosure, the first processor is further configured to inquire of a PCF about a network policy corresponding to a second service request from a UE in accordance with the second service request, and inquire of an NRF about a UPF service corresponding to the second service request.

In a possible embodiment of the present disclosure, the second service request includes a PDU session establishment request.

In a possible embodiment of the present disclosure, the first processor is further configured to: call a transmission path establishment service of the UPF during the establishment of the PDU session, and establish a policy control service calling path with the UPF; and call the policy control service of the UPF through the policy control service calling path.

In still yet another aspect, the present disclosure provides in some embodiments a network device, including a second processor and a second transceiver. The second processor is configured to perform configuration in accordance with a policy control service. The policy control service is used to configure a network policy for a UPF, or configure the network policy and network policy triggering information for the UPF.

In a possible embodiment of the present disclosure, the policy control service includes at least one of policy control service creation, policy control service update and policy control service deletion.

In a possible of the present disclosure, the network policy includes at least one of QoS policy, lawful interception policy and charging policy.

In a possible embodiment of the present disclosure, the network policy triggering information indicates that a corresponding network policy is triggered when the transmission of a data packet has been detected after the establishment of a PDU session; or indicates that a corresponding network policy is triggered when the transmission of a target data stream has been detected after the establishment of the PDU session.

In a possible embodiment of the present disclosure, the second transceiver is further configured to: receive a first service request from a calling end, the first service request including the network policy, or the network policy and the network policy triggering information; and transmit a first service response to the calling end after performing the configuration in accordance with the first service request.

In a possible embodiment of the present disclosure, the second processor is further configured to register a service supported by the UPF itself to an NRF via a service-based interface.

In still yet another aspect, the present disclosure provides in some embodiments a UPF configuration apparatus for a network device, including a first processing module configured to call a policy control service of a UPF. The policy control service is used to configure a network policy for the UPF, or configure the network policy and network policy triggering information for the UPF.

In still yet another aspect, the present disclosure provides in some embodiments a UPF configuration apparatus for a UPF, including a second processing module configured to perform configuration in accordance with a policy control service. The policy control service is used to configure a network policy for the UPF, or configure the network policy and network policy triggering information for the UPF.

In still yet another aspect, the present disclosure provides in some embodiments a network device, including a transceiver, a memory, a processor, and a computer program stored in the memory and executed by the processor. The processor is configured to execute the computer program so as to implement the above-mentioned UPF configuration method for the network device.

In still yet another aspect, the present disclosure provides in some embodiments a network device, including a transceiver, a memory, a processor, and a computer program stored in the memory and executed by the processor. The processor is configured to execute the computer program so as to implement the above-mentioned UPF configuration method for the UPF.

In still yet another aspect, the present disclosure provides in some embodiments a computer-readable storage medium storing therein a computer program. The computer program is executed by a processor so as to implement the steps in the UPF configuration method for the network device, or implement the steps in the UPF configuration method for the UPF.

The present disclosure has the following beneficial effect. In the UPF configuration method for the network device according to the embodiments of the present disclosure, through calling the policy control service of the UPF, it is able to configure the network policy for the UPF, or the network policy and the network policy triggering information, for the UPF on demand, thereby to prevent the occurrence of resource waste.

### BRIEF DESCRIPTION OF THE DRAWINGS

FIG. 1 is a flow chart of a UPF configuration method for a network device according to one embodiment of the present disclosure;

FIG. 2 is another flow chart of the UPF configuration method for the network device according to one embodiment of the present disclosure;

FIG. 3 is a schematic view showing the application of the UPF configuration method according to one embodiment of the present disclosure;

FIG. 4 is a flow chart of a UPF configuration method for a UPF according to one embodiment of the present disclosure;

FIG. 5 is a schematic view showing the network device according to one embodiment of the present disclosure;

FIG. 6 is another schematic view showing the network device according to one embodiment of the present disclosure;

FIG. 7 is a schematic view showing a UPF configuration apparatus for the network device according to one embodiment of the present disclosure;

FIG. 8 is a schematic view showing a UPF configuration apparatus for the UPF according to one embodiment of the present disclosure;

FIG. 9 is yet another schematic view showing the network device according to one embodiment of the present disclosure; and

FIG. 10 is still yet another schematic view showing the network device according to one embodiment of the present disclosure.

### DETAILED DESCRIPTION

In order to make the objects, the technical solutions and the advantages of the present disclosure more apparent, the present disclosure will be described hereinafter in a clear and complete manner in conjunction with the drawings and embodiments.

In the related art, 5G SBA merely supports the service procedures of an interface in a control plane of a 5G core network, so a UPF needs to have a universal set of functions. In the implementations of different slices, the functions of the UPF may probably be wasted. An object of the present disclosure is to provide a UPF configuration method, so as to call the functions of the UPF on demand, thereby to prevent the occurrence of resource waste.

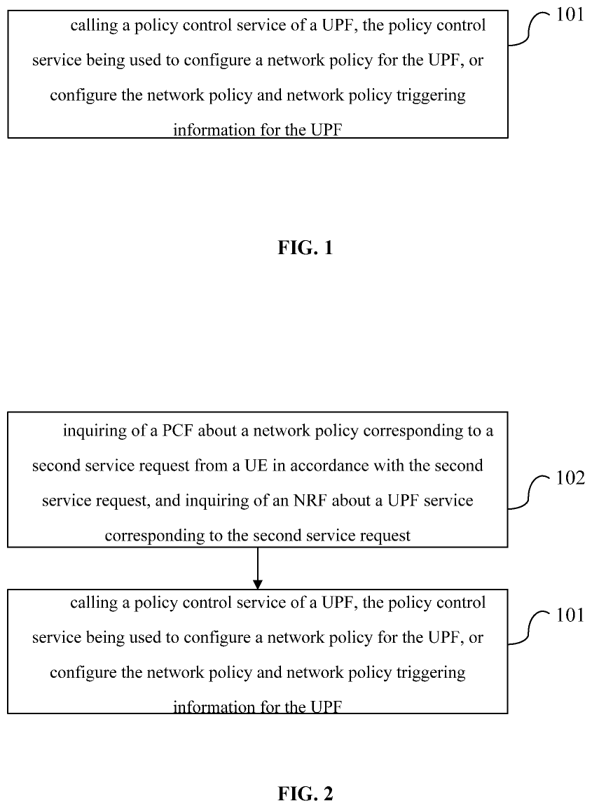

As shown in FIG. 1, the present disclosure provides in some embodiments a UPF configuration method for a network device, which includes Step 101 of calling a policy control service of a UPF. The policy control service is used to configure a network policy for the UPF, or configure the network policy and network policy triggering information for the UPF.

According to the UPF configuration method for the network device in the embodiments of the present disclosure, through Step 101 of calling the policy control service of the UPF, it is able to configure the network policy for the UPF, or the network policy and the network policy triggering information, for the UPF on demand, thereby to prevent the occurrence of resource waste.

In the embodiments of the present disclosure, the network device may include, but not limited to, an SMF, and the network policy triggering information may be used to indicate a triggering condition corresponding to the network policy. Of course, when the network policy triggering information is set by the UPF by default, the policy control service does not need to include the network policy triggering information. The policy control service may also be called or considered as a policy service or a control service.

In a possible embodiment of the present disclosure, the policy control service may include at least one of policy control service creation, policy control service update and policy control service deletion.

Here, the policy control service creation relates to the addition of a new network policy, or new network policy and network policy triggering information, to the UPF. The policy control service update refers to the replacement of an existing network policy, or existing network policy and network policy triggering information, with a new configuration. The policy control service deletion refers to the deletion of the existing network policy, or the existing network policy and network policy triggering information.

In a possible of the present disclosure, the network policy may include at least one of QoS policy, lawful interception policy and charging policy.

Of course, the network policy configured for the UPF may include, but not limited to, the QoS policy, the lawful interception policy and the charging policy.

In a possible embodiment of the present disclosure, the network policy triggering information indicates that a corresponding network policy is triggered when the transmission of a data packet has been detected after the establishment of a PDU session; or indicates that a corresponding network policy is triggered when the transmission of a target data stream has been detected after the establishment of the PDU session.

In this regard, after the network policy triggering information has been configured for the UPF, the UPF may monitor the transmission of the data packet after the establishment of the PDU session, and when the transmission of the data packet has been detected, trigger the corresponding network policy; or monitor the transmission of the data stream after the establishment of the PDU session, and when the target data stream has been detected, trigger the corresponding network policy. Identically, the above-mentioned network policy triggering information is merely a preferred implementation, and the other appropriate network policy triggering information will not be particularly defined herein.

In addition, in order to call the policy control service, in some embodiments of the present disclosure, Step 101 may include: transmitting a first service request to the UPF, the first service request including the network policy, or the network policy and the network policy triggering information; and receiving a first service response from the UPF.

The network device may transmit the first service request (which includes the network policy, or the network policy and the network policy triggering information, for the UPF) to the UPF, so that the UPF may perform the corresponding configuration. Then, the network device may receive the first service response from the UPF, and acquire a current configuration result.

In addition, it should be appreciated that, the policy control service creation, the policy control service update and the policy control service deletion may be implemented in a request/response form, which will not be particularly defined herein.

In addition, it should be further appreciated that, in the embodiments of the present disclosure, the UPF may register a service supported by itself to an NRF via a service-based interface. The service may include, but not limited to, the policy control service, and a path establishment related service. In order to understand a UPF service and use the UPF service in a targeted manner, in a possible embodiment of the present disclosure, as shown in FIG. 2, prior to Step 101, the UPF configuration method may further include Step 102 of inquiring of a PCF about a network policy corresponding to a second service request from a UE in accordance with the second service request, and inquiring of an NRF about a UPF service corresponding to the second service request.

In this way, with respect to the UE, the network device may, on one hand, inquire of the PCF about the corresponding network policy, and on the other hand, inquire of the NRF of the corresponding UPF service, so as to search for a UPF address.

The second service request may include a PDU session establishment request.

Of course, the PDU session establishment request is merely one implementation mode of the second service request, and the second service request may include, but not limited to the PDU session establishment request.

In order to call the UPF service, in a possible embodiment of the present disclosure, prior to calling the policy control service of the UPF, the UPF configuration method may further include calling a transmission path establishment service of the UPF during the establishment of the PDU session, and establishing a policy control service calling path with the UPF. The calling the policy control service of the UPF may include calling the policy control service of the UPF through the policy control service calling path.

In this way, in a PDU session establishment process, the network device may call the transmission path establishment service, and establish the policy control service calling path with the UPF. Then, the network device may call the policy control service of the UPF through the policy control service calling path, so as to configure the network policy for the UPF in a better manner.

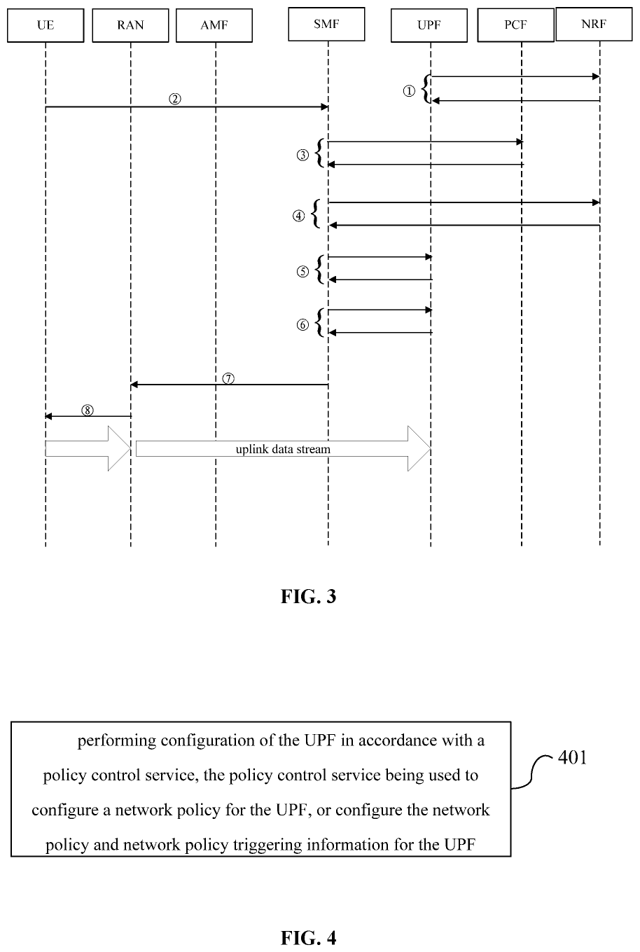

The application of the UPF configuration method will be described hereinafter in conjunction with FIG. 3.

\textcircled{1} The UPF may register the service supported by itself to the NRF via a service-based interface. The service may include, but not limited to, the policy control service and the path establishment related service. The registration may be implemented in a request/response form.

\textcircled{2} The UE may initiate a PDU session establishment request, and the request may be delivered to an SMF via an RAN and an AMF.

\textcircled{3} The SMF may acquire a network policy related to the establishment of the PDU session from the PCF, and the network policy may include, but not limited to, the QoS policy, the lawful interception policy, the charging policy and the routing policy.

\textcircled{4} The SMF may also inquire of the NRF about the UPF services satisfying the requirement on the establishment of the PDU session. At this time, the NRF may return a specific inquiry result, and the inquiry result may include a series of service instances of the services and addresses thereof. The SMF may select an appropriate UPF service.

\textcircled{5} The SMF may call the transmission path establishment service of the UPF. In this step, the UPF may acquire related tunnel information, so as to establish the policy control service calling path between the UPF and the SMF.

\textcircled{6} The SMF may call the policy control service of the UPF through the established policy control service calling path. The network policy acquired in Step \textcircled{3}, or the network policy and the network policy triggering information, may be configured for the UPF.

\textcircled{7} The SMF may deliver the acquired UPF tunnel information about an N3 interface to the RAN.

\textcircled{8} The RAN may transmit a feedback to the UE, so as to establish a radio resource for the PDU session.

In a word, according to the UPF configuration method for the network device in the embodiments of the present disclosure, through calling the policy control service of the UPF, it is able to configure the network policy for the UPF, or the network policy and the network policy triggering information, for the UPF on demand, thereby to prevent the occurrence of resource waste.

As shown in FIG. 4, the present disclosure further provides in some embodiments a UPF configuration method for a UPF, which includes Step 401 of performing configuration in accordance with a policy control service. The policy control service is used to configure a network policy for the UPF, or configure the network policy and network policy triggering information for the UPF.

Through Step 401, the UPF may configure the network policy, or the network policy and the network policy triggering information, in a targeted manner in accordance with the policy control service, so as to apply the UPF service appropriately, thereby to prevent the occurrence of resource waste.

In a possible embodiment of the present disclosure, the policy control service may include at least one of policy control service creation, policy control service update and policy control service deletion.

In a possible of the present disclosure, the network policy may include at least one of QoS policy, lawful interception policy and charging policy.

In a possible embodiment of the present disclosure, the network policy triggering information indicates that a corresponding network policy is triggered when the transmission of a data packet has been detected after the establishment of a PDU session; or indicates that a corresponding network policy is triggered when the transmission of a target data stream has been detected after the establishment of the PDU session.

The performing the configuration in accordance with the policy control service may include: receiving a first service request from a calling end, the first service request including the network policy, or the network policy and the network policy triggering information; and transmitting a first service response to the calling end after performing the configuration in accordance with the first service request.

Prior to performing the configuration in accordance with the policy control service, the UPF configuration method may further include registering a service supported by the UPF itself to an NRF via a service-based interface.

It should be appreciated that, this UPF configuration method for the UPF is used to cooperate with the above-mentioned UPF configuration method for the network device, and the embodiments of the above-mentioned UPF configuration method for the network device may also be applied to the UPF configuration method for the UPF with a same technical effect.

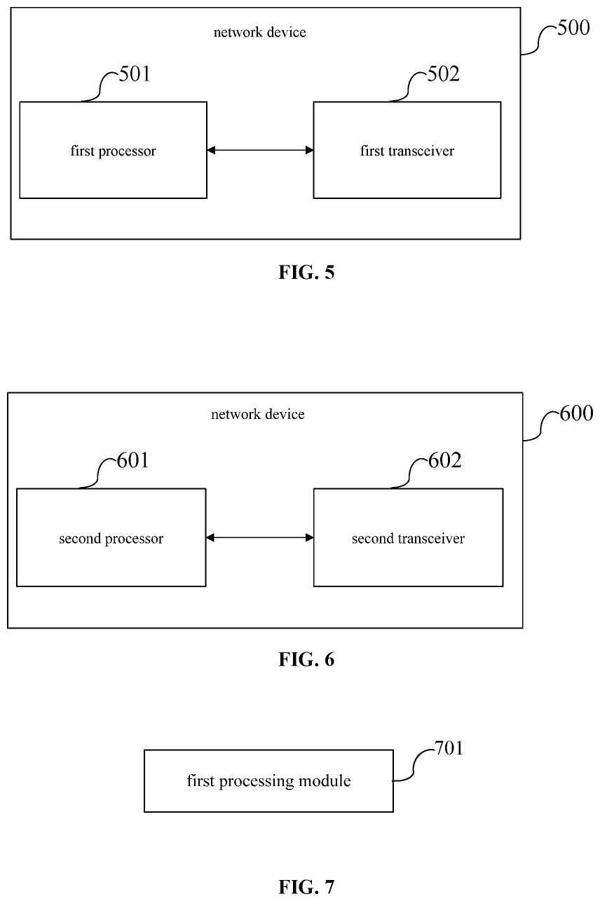

As shown in FIG. 5, the present disclosure further provides in some embodiments a network device 500, which includes a first processor 501 and a first transceiver 502. The first processor 501 is configured to call a policy control service of a UPF. The policy control service is used to configure a network policy for the UPF, or configure the network policy and network policy triggering information for the UPF.

The policy control service may include at least one of policy control service creation, policy control service update and policy control service deletion.

The network policy may include at least one of QoS policy, lawful interception policy and charging policy.

The network policy triggering information indicates that a corresponding network policy is triggered when the transmission of a data packet has been detected after the establishment of a PDU session; or indicates that a corresponding network policy is triggered when the transmission of a target data stream has been detected after the establishment of the PDU session.

The first transceiver 502 is configured to: transmit a first service request to the UPF, the first service request including the network policy, or the network policy and the network policy triggering information; and receive a first service response from the UPF.

The first processor 501 is further configured to inquire of a PCF about a network policy corresponding to a second service request from a UE in accordance with the second service request, and inquire of an NRF about a UPF service corresponding to the second service request.

The second service request may include a PDU session establishment request.

The first processor 501 is further configured to: call a transmission path establishment service of the UPF during the establishment of the PDU session, and establish a policy control service calling path with the UPF; and call the policy control service of the UPF through the policy control service calling path.

According to the network device in the embodiments of the present disclosure, through calling the policy control service of the UPF, it is able to configure the network policy for the UPF, or the network policy and the network policy triggering information, for the UPF on demand, thereby to prevent the occurrence of resource waste.

As shown in FIG. 6, the present disclosure further provides in some embodiments a network device 600, which includes a second processor 601 and a second transceiver 602. The second processor 601 is configured to perform configuration in accordance with a policy control service. The policy control service is used to configure a network policy for the UPF, or configure the network policy and network policy triggering information for the UPF.

The policy control service may include at least one of policy control service creation, policy control service update and policy control service deletion.

The network policy may include at least one of QoS policy, lawful interception policy and charging policy.

The network policy triggering information indicates that a corresponding network policy is triggered when the transmission of a data packet has been detected after the establishment of a PDU session; or indicates that a corresponding network policy is triggered when the transmission of a target data stream has been detected after the establishment of the PDU session.

The second transceiver 602 is further configured to: receive a first service request from a calling end, the first service request including the network policy, or the network policy and the network policy triggering information; and transmit a first service response to the calling end after performing the configuration in accordance with the first service request.

The second processor 601 is further configured to register a service supported by the UPF itself to an NRF via a service-based interface.

According to the network device in the embodiments of the present disclosure, the network policy, or the network policy and the network policy triggering information, may be configured in a targeted manner in accordance with the policy control service, so as to apply the UPF service appropriately, thereby to prevent the occurrence of resource waste.

As shown in FIG. 7, the present disclosure further provides in some embodiments a UPF configuration apparatus for a network device, which includes a first processing module 701 configured to call a policy control service of a UPF. The policy control service is used to configure a network policy for the UPF, or configure the network policy and network policy triggering information for the UPF.

The policy control service may include at least one of policy control service creation, policy control service update and policy control service deletion.

The network policy may include at least one of QoS policy, lawful interception policy and charging policy.

The network policy triggering information indicates that a corresponding network policy is triggered when the transmission of a data packet has been detected after the establishment of a PDU session; or indicates that a corresponding network policy is triggered when the transmission of a target data stream has been detected after the establishment of the PDU session.

The first processing module may include: a first transmission sub-module configured to transmit a first service request to the UPF, the first service request including the network policy, or the network policy and the network policy triggering information; and a first reception sub-module configured to receive a first service response from the UPF.

The UPF configuration apparatus may further include an inquiry module configured to inquire of a PCF about a network policy corresponding to a second service request from a UE in accordance with the second service request, and inquire of an NRF about a UPF service corresponding to the second service request.

The second service request may include a PDU session establishment request.

The UPF configuration apparatus may further include a path establishment module configured to call a transmission path establishment service of the UPF during the establishment of the PDU session, and establish a policy control service calling path with the UPF. The first processing module is further configured to call the policy control service of the UPF through the policy control service calling path.

The UPF configuration apparatus may be applied to the network device. Through calling the policy control service of the UPF, it is able to configure the network policy for the UPF, or the network policy and the network policy triggering information, for the UPF on demand, thereby to prevent the occurrence of resource waste.

It should be appreciated that, the UPF configuration apparatus corresponds to the above-mentioned UPF configuration method for the network device, and the implementation of the above-mentioned UPF configuration method for the network device may also be applied to the UPF configuration apparatus with a same technical effect.

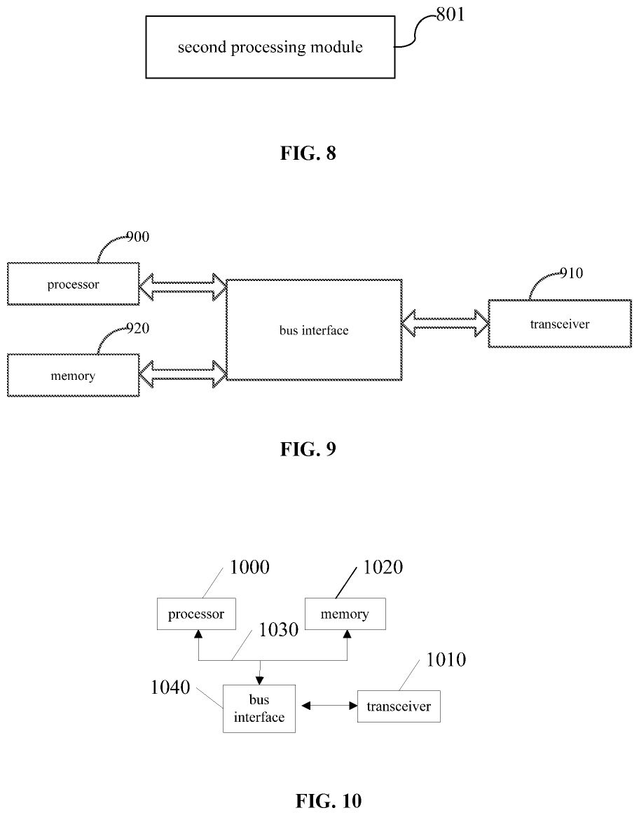

As shown in FIG. 8, the present disclosure further provides in some embodiments a UPF configuration apparatus for a UPF, which includes a second processing module 801 configured to perform configuration in accordance with a policy control service. The policy control service is used to configure a network policy for the UPF, or configure the network policy and network policy triggering information for the UPF.

The policy control service may include at least one of policy control service creation, policy control service update and policy control service deletion.

The network policy may include at least one of QoS policy, lawful interception policy and charging policy.

The network policy triggering information indicates that a corresponding network policy is triggered when the transmission of a data packet has been detected after the establishment of a PDU session; or indicates that a corresponding network policy is triggered when the transmission of a target data stream has been detected after the establishment of the PDU session.

The second processing module 801 may include: a second reception module configured to receive a first service request from a calling end, the first service request including the network policy, or the network policy and the network policy triggering information; and a second transmission module configured to transmit a first service response to the calling end after performing the configuration in accordance with the first service request.

The UPF configuration apparatus may further include a registration module configured to register a service supported by the UPF itself to an NRF via a service-based interface.

The present disclosure further provides in some embodiments a network device which, as shown in FIG. 9, includes a transceiver 910, a memory 920, a processor 900, and a computer program stored in the memory 920 and executed by the processor 900. The processor 900 is configured to execute the computer program so as to implement the above-mentioned UPF configuration method for the network device. The transceiver 910 is configured to receive and transmit data under the control of the processor 900.

In FIG. 9, bus architecture may include a number of buses and bridges connected to each other, so as to connect various circuits for one or more processors 900 and one or more memories 920. In addition, as is known in the art, the bus architecture may be used to connect any other circuits, such as a circuit for a peripheral device, a circuit for a voltage stabilizer and a power management circuit. A bus interface may be provided, and the transceiver 910 may consist of a plurality of elements, i.e., a transmitter and a receiver for communication with any other devices over a transmission medium. The processor 900 may take charge of managing the bus architecture as well as general processings. The memory 920 may store therein data for the operation of the processor 900.

The present disclosure further provides in some embodiments a network device which, as shown in FIG. 10, includes a transceiver 1010, a memory 1020, a processor 1000, and a computer program stored in the memory 1020 and executed by the processor 1000. The processor 1000 is configured to execute the computer program so as to implement the above-mentioned UPF configuration method for the network device. The transceiver 1010 is configured to receive and transmit data under the control of the processor 1000.

In FIG. 10, bus architecture (represented by a bus 1030) may include a number of buses and bridges connected to each other, so as to connect various circuits for one or more processors 1000 and one or more memories 1020. In addition, as is known in the art, the bus 1030 may be used to connect any other circuits, such as a circuit for a peripheral device, a circuit for a voltage stabilizer and a power management circuit. A bus interface 1040 may be provided between the bus 1030 and the transceiver 1010, and the transceiver 1010 may consist of a plurality of elements, i.e., a transmitter and a receiver for communication with any other devices over a transmission medium. The processor 1000 may take charge of managing the bus 1030 as well as general processings, and provide various functions such as timing, peripheral interfacing, voltage adjustment, power source management and any other control functions. The memory 1020 may store therein data for the operation of the processor 1000.

In a possible embodiment of the present disclosure, the first processor 1000 may be a Central Processing Unit (CPU), an Application Specific Integrated Circuit (ASIC), a Field-Programmable Gate Array (FPGA) or a Complex Programmable Logic Device (CPLD).

The present disclosure further provides in some embodiments a computer-readable storage medium storing therein a computer program. The computer program is executed by a processor so as to implement the steps in the above-mentioned UPF configuration method for the network device, or implement the steps in the above-mentioned UPF configuration method for the UPF with a same technical effect, which will not be particularly defined herein. The computer-readable storage medium may be a Read-Only Memory (ROM), a Random Access Memory (RAM), a magnetic disk or an optical disk.

It should be further appreciated that, the UE described in the specification may include, but not limited to, smart phone or tablet computer. The functional members described in the specification may be referred to as modules, so as to emphasize the independence of the implementation in a more particular manner.

According to the embodiments of the present disclosure, the modules may be implemented by software, so as to be executed by various processors. For example, an identified, executable code module may comprise one or more physical or logical blocks including computer instructions, and the module can be constructed as an image, a process or a function. Even so, the executable codes of the identified modules are unnecessary to be physically located together, but may comprise different instructions stored in different locations. When these instructions are logically combined together, they form the modules and achieve the prescribed purposes of the modules.

Actually, the executable code module may be a single instruction or a plurality of instructions, and can even be distributed at different code segments, in different programs, or across a plurality of memory devices. Also, operational data may be identified in the modules, implemented in any appropriate form, and organized in any data structure of an appropriate type. The operational data may be collected as a single data set, or distributed at different locations (including different memory devices), and may be at least partially present in a system or network merely as an electronic signal.

When the modules can be implemented by software, considering the current hardware level, a person skilled in the art can build a corresponding hardware circuit to achieve the corresponding function if taking no account of the cost. The hardware circuit comprises a conventional very-large-scale integration (VLSI) circuit, a gate array, an existing semiconductor such as a logic chip and a transistor, or other discrete components. The modules may further be implemented by a programmable hardware device, such as a field-programmable gate array, a programmable array logic device and a programmable logic device.

The above illustrative embodiments have been described with respect to the drawings, and the other embodiments may also feasible without departing from the spirit and teaching of the present disclosure, so the illustrative embodiments shall not be used to limit the scope of the present disclosure. More definitely, the illustrative embodiments are provided so as to make the present disclosure complete, and deliver the scope of the present disclosure to those skilled in the art. In the drawings, sizes and relative sizes of the members may be scaled up for clarification. Terms involved in the present disclosure are merely used to describing the specific embodiments, but shall not be inclined to become a restricted use. Unless otherwise defined, such words as “one” or “one of” are merely used to represent the existence of at least one member, rather than to limit the number thereof. Such words as “include” or “including” intend to indicate that there are the features, integers, steps, operations, elements and/or assemblies, without excluding the existence or addition of one or more other features, integers, steps, operations, elements, assemblies and/or combinations thereof. Unless otherwise defined, a numerical range may include an upper limit, a lower limit and any sub-range.

The above embodiments are for illustrative purposes only, but the present disclosure is not limited thereto. Obviously, a person skilled in the art may make further modifications and improvements without departing from the spirit of the present disclosure, and these modifications and improvements shall also fall within the scope of the present disclosure.

1. A User Plane Function (UPF) configuration method for a network device, comprising:
calling a policy control service of a UPF, wherein the policy control service is used to configure a network policy for the UPF, or configure the network policy and network policy triggering information for the UPF.

2. The UPF configuration method according to claim 1, wherein the policy control service comprises at least one of policy control service creation, policy control service update and policy control service deletion.

3. The UPF configuration method according to claim 1, wherein the network policy comprises at least one of Quality of Service (QoS) policy, lawful interception policy and charging policy.

4. The UPF configuration method according to claim 1, wherein the network policy triggering information indicates that a corresponding network policy is triggered when the transmission of a data packet has been detected after the establishment of a Packet Data Unit (PDU) session; or indicates that a corresponding network policy is triggered when the transmission of a target data stream has been detected after the establishment of the PDU session.

5. The UPF configuration method according to claim 1, wherein the calling the policy control service of the UPF comprises:
transmitting a first service request to the UPF, wherein the first service request comprises the network policy, or both the network policy and the network policy triggering information; and
receiving a first service response from the UPF.

6. The UPF configuration method according to claim 1, wherein prior to calling the policy control service of the UPF, the UPF configuration method further comprises:
inquiring of a Policy Control Function (PCF) about a network policy corresponding to a second service request from a User Equipment (UE) in accordance with the second service request, and
inquiring of a Network Function Repository Function (NRF) about a UPF service corresponding to the second service request,
wherein the second service request comprises a PDU session establishment request.

7. (canceled)

8. The UPF configuration method according to claim 1, wherein prior to calling the policy control service of the UPF, the UPF configuration method further comprises:
calling a transmission path establishment service of the UPF during the establishment of the PDU session, and establishing a policy control service calling path with the UPF,
wherein the calling the policy control service of the UPF comprises calling the policy control service of the UPF through the policy control service calling path.

9. A User Plane Function (UPF) configuration method for a UPF, comprising:
performing configuration of the UPF in accordance with a policy control service, wherein the policy control service is used to configure a network policy for the UPF, or configure the network policy and network policy triggering information for the UPF.

10. The UPF configuration method according to claim 9, wherein the policy control service comprises at least one of policy control service creation, policy control service update and policy control service deletion.

11. The UPF configuration method according to claim 9, wherein the network policy comprises at least one of Quality of Service (QoS) policy, lawful interception policy and charging policy.

12. The UPF configuration method according to claim 9, wherein the network policy triggering information indicates that a corresponding network policy is triggered when the transmission of a data packet has been detected after the establishment of a Packet Data Unit (PDU) session; or indicates that a corresponding network policy is triggered when the transmission of a target data stream has been detected after the establishment of the PDU session.

13. The UPF configuration method according to claim 9, wherein the performing the configuration in accordance with the policy control service comprises:
receiving a first service request from a calling end, wherein the first service request comprises the network policy, or both the network policy and the network policy triggering information; and
transmitting a first service response to the calling end after performing the configuration in accordance with the first service request,
wherein prior to performing the configuration in accordance with the policy control service, the UPF configuration method further comprises registering a service supported by the UPF itself to a Network Function Repository Function (NRF) via a service-based interface.

14. (canceled)

15. A network device, comprising a first processor and a first transceiver, wherein the first processor is configured to call a policy control service of a User Plane Function (UPF), and the policy control service is used to configure a network policy for the UPF, or configure the network policy and network policy triggering information for the UPF.

16. The network device according to claim 15, wherein the policy control service comprises at least one of policy control service creation, policy control service update and policy control service deletion,
wherein the network policy comprises at least one of Quality of Service (QoS) policy, lawful interception policy and charging policy,
wherein the network policy triggering information indicates that a corresponding network policy is triggered when the transmission of a data packet has been detected after the establishment of a Packet Data Unit (PDU) session; or indicates that a corresponding network policy is triggered when the transmission of a target data stream has been detected after the establishment of the PDU session.

17-18. (canceled)

19. The network device according to claim 15, wherein the first transceiver is configured to: transmit a first service request to the UPF, wherein the first service request comprises the network policy, or both the network policy and the network policy triggering information; and receive a first service response from the UPF.

20. The network device according to claim 15, wherein the first processor is further configured to inquire of a Policy Control Function (PCF) about a network policy corresponding to a second service request from a User Equipment (UE) in accordance with the second service request, and inquire of a Network Function Repository Function (NRF) about a UPF service corresponding to the second service request,
wherein the second service request comprises a PDU session establishment request.

21. (canceled)

22. The network device according to claim 15, wherein the first processor is further configured to: call a transmission path establishment service of the UPF during the establishment of the PDU session, and establish a policy control service calling path with the UPF; and call the policy control service of the UPF through the policy control service calling path.

23. A network device, comprising a second processor and a second transceiver, wherein the second processor is configured to perform the User Plane Function (UPF) configuration method according to claim 9.

24. The network device according to claim 23, wherein the policy control service comprises at least one of policy control service creation, policy control service update and policy control service deletion,
wherein the network policy comprises at least one of Quality of Service (QoS) policy, lawful interception policy and charging policy,
wherein the network policy triggering information indicates that a corresponding network policy is triggered when the transmission of a data packet has been detected after the establishment of a Packet Data Unit (PDU) session; or indicates that a corresponding network policy is triggered when the transmission of a target data stream has been detected after the establishment of the PDU session.

25-26. (canceled)

27. The network device according to claim 23, wherein the second transceiver is further configured to: receive a first service request from a calling end, the first service request comprising the network policy, or the network policy and the network policy triggering information; and transmit a first service response to the calling end after performing the configuration in accordance with the first service request,
wherein the second processor is further configured to register a service supported by the UPF itself to a Network Function Repository Function (NRF) via a service-based interface.

28-33. (canceled)
